(19) United States
(12) Patent Application Publication
(10) Pub. No.: US 2010/0252941 A1
(43) Pub. Date: Oct. 7, 2010

(54) OPTICAL ELEMENT MANUFACTURING METHOD

(75) Inventors: Hirofumi Fujii, Utsunomiya-shi (JP); Ken Katsuta, Utsunomiya-shi (JP); Hidenori Hashiguchi, Utsunomiya-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/755,135

(22) Filed: Apr. 6, 2010

(30) Foreign Application Priority Data
Apr. 7, 2009 (JP) 2009-093401

(51) Int. Cl. B29D 11/00

(52) U.S. Cl. 264/1.24

(57) ABSTRACT

A method of manufacturing an optical element used at a second air pressure different from a first air pressure comprises: a measuring step of measuring a surface shape of the optical member at the first air pressure; a calculating step of calculating a deformation amount of the optical member that occurs owing to an air pressure difference between the first air pressure and the second air pressure; and a processing step of processing the optical member at the first air pressure so as to make the surface shape of the optical member match a target shape at the second air pressure, based on the surface shape measured in the measuring step and the deformation amount calculated in the calculating step.

### BACKGROUND OF THE INVENTION

1. Field of the Invention

The present invention relates to an optical element manufacturing method.

2. Description of the Related Art

According to a conventional method of manufacturing an optical element used in the optical system of an exposure apparatus, the surface shape of an optical member is measured and the optical member is processed based on the measurement result. Especially in an exposure apparatus, an unwanted aberration occurs if the surface shape of a manufactured optical element differs from a desired one. Therefore the measurement and processing errors need to be minimized. Japanese Patent Laid-Open No. 2006-220471 discloses a measurement apparatus that measures the surface shape of an optical element. The measurement apparatus described in Japanese Patent Laid-Open No. 2006-220471 measures the surface shape of an optical element using an interferometer. The thermally deformed shapes of reference and test surfaces are calculated, and test surface shape data processed by a two-dimensional image processing apparatus is corrected based on the calculation result.

As light emitted by a light source, a conventional exposure apparatus uses light which is not so greatly attenuated even after passing through gas. However, the wavelength of light emitted by a light source needs to be shorter for higher resolutions demanded from recent exposure apparatuses. This boosts the development of exposure apparatuses using a light source that emits short-wavelength light such as extreme ultra violet (EUV) light. However, short-wavelength light is attenuated much more than light emitted by a conventional light source after passing through gas. Considering this, a space where light passes is vacuumed in an exposure apparatus that uses short-wavelength light for exposure.

An optical member for manufacturing an optical element is often measured and processed in the air. When the optical element of an exposure apparatus used in a reduced-pressure environment such as a vacuum environment is manufactured at the atmospheric pressure, a pressure environment where an optical member for manufacturing an optical element is measured and processed differs from that where the manufactured optical element is used in exposure and the like. A change of the pressure environment leads to a change of the stress on the surface of the optical element by the pressure. As a result, the optical element is deformed. If an optical element is manufactured without considering the deformation of the optical element upon a pressure change, neither desired optical performance nor desired resolving performance is obtained in exposure. To prevent this, the surface shape of an optical member is measured and processed in a pressure environment, for example, vacuum environment where the optical element of an exposure apparatus is used. However, this requires time for vacuuming the optical member and its ambient environment and time for stabilizing a temperature change caused by vacuuming. The manufacture of the optical element becomes time-consuming.

### SUMMARY OF THE INVENTION

The present invention provides a method that efficiently manufactures an optical element having a target shape in a pressure environment where the optical element is used, different from that where it is manufactured.

According to the present invention, there is provided a method of processing an optical member at a first air pressure, thereby manufacturing an optical element used at a second air pressure different from the first air pressure, the method comprising: a measuring step of measuring a surface shape of the optical member at the first air pressure; a calculating step of calculating a deformation amount of the optical member that occurs owing to an air pressure difference between the first air pressure and the second air pressure; and a processing step of processing the optical member at the first air pressure so as to make the surface shape of the optical member match a target shape at the second air pressure, based on the surface shape measured in the measuring step and the deformation amount calculated in the calculating step.

Further features of the present invention will become apparent from the following description of exemplary embodiments with reference to the attached drawings.

### BRIEF DESCRIPTION OF THE DRAWINGS

FIG. 1 is a view showing a measurement apparatus that measures the shape of an optical member;

FIG. 2 is a flowchart showing a sequence of manufacturing an optical element;

FIG. 3 is a view showing a measurement apparatus in a reduced-pressure environment;

FIG. 4 is a view showing measurement data;

FIG. 5 is a graph showing corrected measurement data;

FIG. 6 is a graph showing a calculated deformation amount that occurs owing to the pressure difference between the vacuum pressure and the atmospheric pressure; and

FIG. 7 is a view showing an optical element.

### DESCRIPTION OF THE EMBODIMENTS

A method of manufacturing an optical element by processing an optical member according to an embodiment of the present invention will be described in detail. The surface shape of an optical member for an optical element used in, for example, an exposure apparatus is measured and processed in a pressure environment different from that in exposure. For example, the pressure environment in the manufacture is the first air pressure (atmospheric pressure), and that in exposure is the second air pressure (vacuum pressure) different from the first air pressure. According to the following method, the deformation amount of the optical member that occurs owing to the difference between air pressures in measurement and exposure is calculated in advanced. A processing amount derived from a measurement value is corrected using the calculated deformation amount, and then the optical element is manufactured. FIG. 1 exemplifies a measurement apparatus that measures the surface shape of an optical member. Parallel light emitted by a light source 103 is condensed by a condenser lens 105 and reflected by a half mirror 108. The reflected light is collimated again into parallel light by a collimator lens 106. Light reflected by the test surface of an optical member 101 to be measured and that reflected by a reference surface 102 interfere with each other. The interference light passes through the collimator lens 106 and half mirror 108 again and is collimated into parallel light by a collimator lens 107. An image sensing device 104 measures the resultant light. In this way, the difference in optical path length between the test surface and the reference surface 102 can be measured. A calculator 110 processes measurement data acquired by the image sensing device 104, obtaining shape data of the optical member 101 to be measured from interference light. At this time, the temperature and pressure in a chamber 109 that stores the optical member 101 are controlled and measured.

[Shape Data of Optical Member]

Shift A from the ideal shape of an optical element is given by the difference (M−R) between shape data M and a target shape R. Shift A from the target shape=(M−R) is used as process data. Conventionally, no problem arose even if deformation of the shape of an optical element by the pressure was not considered because the shape precision of a necessary optical element was not so high and the pressure environment in exposure was not the vacuum environment. However, the pressure environment in exposure needs to be taken into account in terms of the shape precision of an optical element. In the embodiment, the difference between shapes in the manufacture and exposure is counted so that the optical element can be fabricated at higher precision than the conventional one. More specifically, a deformation amount B that occurs due to the difference between air pressures in the manufacture and exposure is considered, and (A+B) is used as process data. In this fashion, the calculator 110 generates process data by adding a deformation amount derived from the difference between air pressures in the manufacture and exposure to measurement data obtained upon measurement by the measurement apparatus. Based on the process data, the shape of the optical member 101 is processed.

First, the surface shape of an optical member is measured at the atmospheric pressure (first air pressure) (measuring step). Then, the deformation amount of the optical member that occurs owing to the difference between the atmospheric pressure (first air pressure) and the vacuum pressure (second air pressure) is calculated (calculating step). Process data is acquired based on the surface shape measured in the measuring step and the deformation amount calculated in the calculating step. Based on the acquired process data, the optical member is processed at the atmospheric pressure (first air pressure) so that the surface shape of the optical member becomes a target shape at the vacuum pressure (second air pressure) (processing step).

Next, a method of calculating the deformation amount of an optical member that occurs owing to the air pressure difference will be described. Practical methods will be explained after a description of a general concept.

As the general concept, the expansion and contraction of an optical element depending on the pressure will be examined. Assume that the optical element is not anisotropic. Since the pressure is isotropically applied to the optical element, distortion occurs isotropically. The isotropically generated distortion will then be examined. For easy understanding, axes on the three-dimensional space will be defined as x, y, and z, and a distortion in the z direction will be considered. Since the pressure is applied isotropically, the same pressure p is applied in the x, y, and z directions. Letting E be the Young's modulus of the pressure-applied optical element and ν be the Poisson's ratio, the distortion α is given by α=(p/E)×(1-2ν). A deformation caused by the pressure difference of the optical element is a matter here, so the deformation will be discussed by paying attention to only the surface of the optical element, and particularly a surface required of the optical element. The surface of the optical element is generally divided into spherical and aspherical surfaces, each of which will be examined.

[Surface with Spherical Shape]

A spherical surface is formed by rotating a curve given by equation (1) around the y-axis passing through the origin:

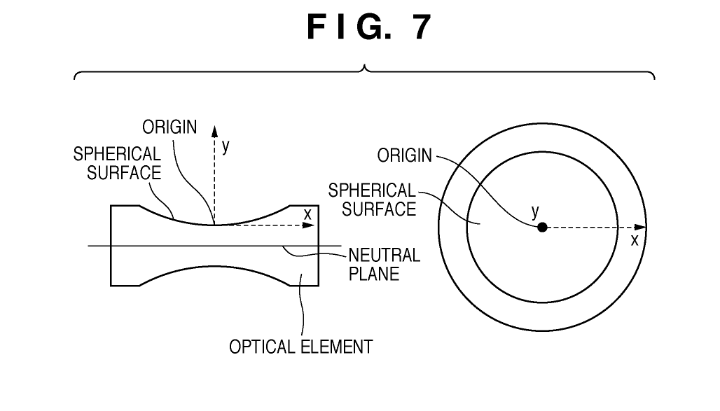

x²+(y−r)²=r² (1)

where r is the radius of the spherical surface. For descriptive convenience, a plane on which deformation does not occur in one direction even upon the pressure difference will be called a neutral plane. For example, a plane of a set of center points of the front and back surfaces can be handled as a neutral plane (FIG. 7). It is easy for an optical element, only a single surface of which is necessary, to design a flat neutral plane. Thus, an optical element designed to have a spherical surface whose neutral plane is flat will be considered. Letting α be distortions in the x and y directions in equation (1), the deformation of the optical element caused by the pressure difference can be expressed by substituting relations between x and y before pressure deformation and x′ and y′ after pressure deformation: x=(1+α)x′ and y=(1+α)y′. These relations represent that the x- and y-axes are distorted by 1/(1+α) upon pressure deformation.

Substituting x=(1+α)x′ and y=(1+α)y′ into equation (1) yields

x′²+{y′−(r/(1+α))²={r/(1+α)}² (2)

Equation (2) indicates that a spherical surface after pressure deformation is a circle having a radius 1/(1+α). That is, an optical element with a spherical shape can be designed to maintain the spherical surface even upon deformation caused by the pressure difference. The deformation amount can be expressed by a simple manual calculation. The radial error of the spherical shape can be permitted to a certain degree by interval adjustment of the optical element or the like. The influence of deformation by the air pressure is negligible.

[Surface with Aspherical Shape]

An optical element whose surface has an aspherical shape will be described. Also in this case, a case in which the neutral plane is flat is assumed for simplifying a model. The aspherical surface is approximated by an aspherical expression:

y(x)=cx²/{1+(1−(1+k)c²x²)^{1/2}+Ax⁴+Bx⁶+ . . . (3)

where c is the reciprocal of the paraxial radius of curvature, x is the distance from the center, A and B are aspherical coefficients, and k is the conic coefficient.
In the right-hand side of equation (3), cx²/{1+(1−(1+k)c²x²)^{1/2}} is a spherical term component, and Ax⁴, Bx⁶, . . . are aspherical term components.

Substituting the relations between x and y before pressure deformation and x′ and y′ after pressure deformation: x=(1+α)x′=βx′ and y=(1+α)y′=βy′ (where β=1+α) into equation (3) yields

y′ (x′)=cβx′²/{1+(1−(1+k)c²β²x′²)^{1/2}}+Aβ⁴x′⁴+Bβ⁶x′⁶+ . . . (4)

A surface given by equation (4) can be regarded as one affected by distortion caused by the atmospheric pressure.
Letting cβ=c′, Aβ⁴=A′, and Bβ⁶=B′, the aspherical expression can be rewritten from equation (4) into equation (5):

y′(x′)=c′x′²/{1+(1−(1+k)c′²x′²)^{1/2}}+A′x′⁴+B′x′⁶+ . . . (5)

That is, the spherical term component indicates that the radius changes β times and the coefficients A, B, . . . with respect to a high-order power of x change by a power of β. This means that the deformation of the shape by the pressure can be examined separately for the spherical and aspherical term components of the aspherical expression. Further, the aspherical surface needs to be coped with by a measure other than interval adjustment of the optical element.

In these calculations, the distortion of a highly symmetrical optical element by the air pressure is calculated using the Young's modulus and Poisson's ratio. In practice, the neutral plane is not flat and the symmetry is poor in many cases. An accurate calculation based on equations is therefore difficult. In terms of a practical use, it is desired to calculate the deformation of a shape considering the influence of the air pressure using a method such as a finite element method.

Two practical methods, that is, analytical and experimental methods will be explained.

[Analytical Method]

According to the analytical method, the deformation amount can be obtained by setting mechanical characteristics (e.g., dimension, density, Young's modulus, and Poisson's ratio) of an optical element in analysis software using the finite element method, such as CAE, and setting a pressure boundary condition on the surface of the optical element. When the optical element is supported by a very flexible spring to avoid deformation by a stress other than the pressure, the influence of holding need not be taken into account. When the surface shape of the optical element is expressed by the foregoing spherical expression, aspherical expression, or the like, the deformation of the optical element by the pressure can be efficiently obtained at high precision by the analytical method. From a comparison between the influence of the spherical term component on a target shape and that of the aspherical term component, the influence of the spherical term component on y′ is often larger by one or more orders of magnitude than that of the aspherical term component and the influence of the spherical term component on the deformation amount is also larger. The reason why the influence of the spherical term component is larger than that of the aspherical term component is that high-precision measurement is impossible in the presence of too many aspherical term components. Hence, when the surface shape of the optical element can be approximated by an aspherical expression, the deformation amount may be calculated efficiently in consideration of only the change amount of the spherical term component in the aspherical expression. A complicated surface shape of the optical element requires fine elements in the analytical method, and an error increases unless elements can be finely set. For a complicated shape, therefore, the deformation amount may be attained by an experimental method.

[Experimental Method]

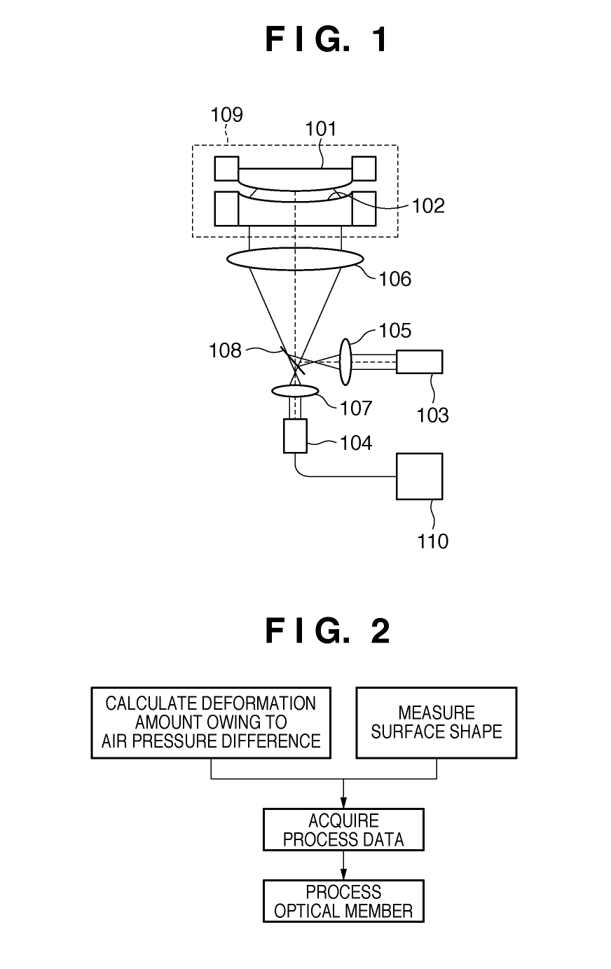

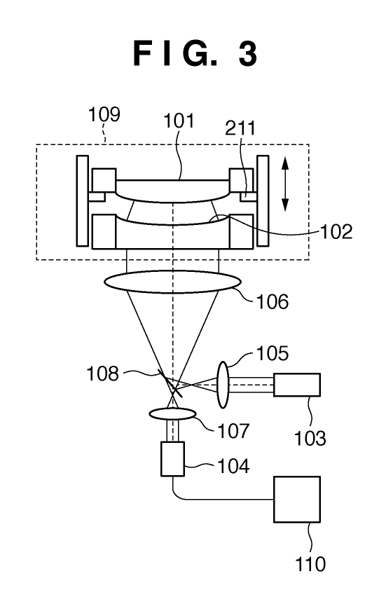

The experimental method is a method of measuring surface shapes at a plurality of pressures which are different from the vacuum pressure (second air pressure) and different from each other, and calculating a deformation amount that occurs owing to the difference between air pressures in the manufacture and exposure, based on the difference between the measured surface shapes of the optical member. FIG. 3 shows a measurement apparatus in a reduced-pressure environment. The interior of the chamber 109 in FIG. 1 is the atmospheric environment, whereas that of the chamber 109 in FIG. 3 is the reduced-pressure environment. If the reference surface 102 is formed from a lens or the like in FIG. 2, it may be distorted upon a change of the pressure, and light different from that at the atmospheric pressure may come from the reference surface 102. To prevent this, the lens that provides the reference surface 102 is formed from an optical system using a pinhole or the like. When the reference surface 102 is spherical and the test surface of the optical member 101 is aspherical, interference occurs at a very narrow portion, so the test surface may be scanned and measured using a driving unit 211. In this way, the measurement data in different pressure environments can be obtained. Note that measurement may be done in a high-vacuum pressure environment as a different pressure environment. However, vacuuming takes a long time until the temperature environment of the measurement apparatus upon an adiabatic change is evened out at a predetermined temperature. Thus, it is desirable to measure the surface shape not in a high-vacuum environment but in a pressure environment of 1,000 Pa or higher where heat is exchanged via gas.

A method of calculating a deformation amount that occurs due to the difference between pressures in the manufacture and exposure will be described. First, measurement data S1 at an air pressure P1 and measurement data S2 at an air pressure P2 are acquired in advance. Let PS be the pressure difference between pressure environments in the manufacture and exposure. Then, the deformation amount B that occurs due to the pressure difference can be calculated by

B=PS×(S1−S2)/(P1−P2) (6)

When the pressure environment in the manufacture is not constant, PS serves as a variable. A pressure in the manufacture need to be measured at high precision and fed back in calculating the deformation amount B.

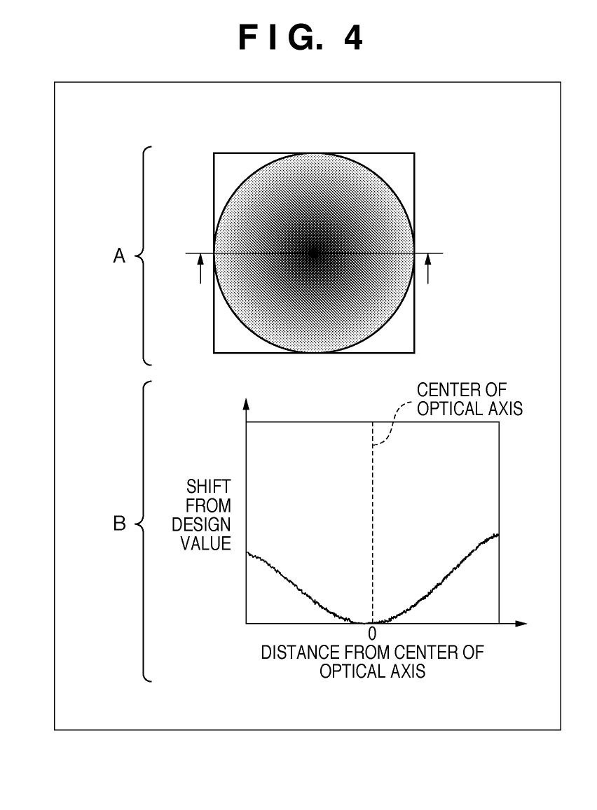

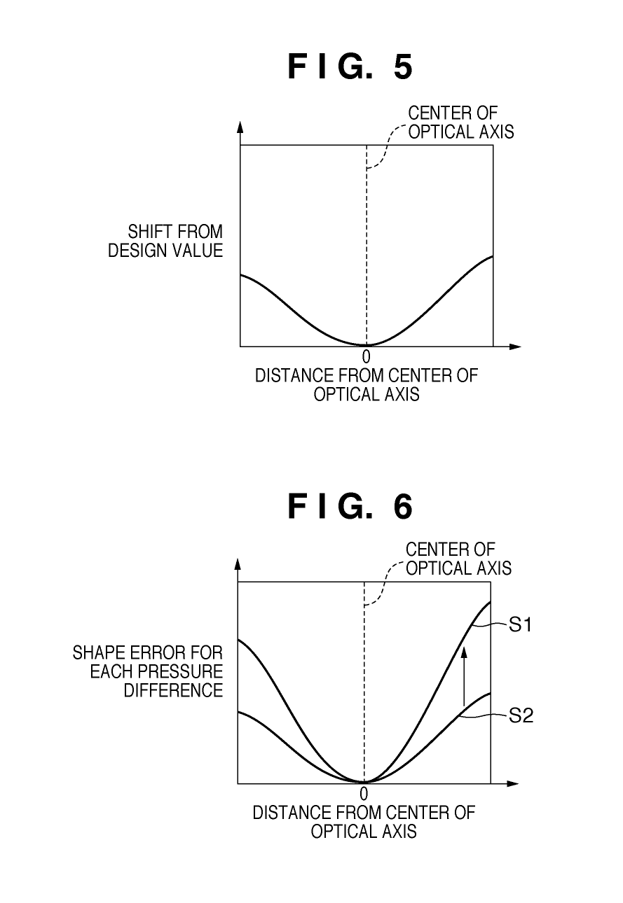

FIGS. 4, 5, and 6 exemplify data processing. Label A of FIG. 4 shows the two-dimensional map of a circular optical element and represents a shift of the optical element from a design value in the normal direction. Label B of FIG. 4 is a graph showing the section of a central part indicated by arrows in the two-dimensional map of label A of FIG. 4. FIG. 5 is a graph showing only the low-frequency component of the shift extracted from the section shown in label B of FIG. 4.

In data processing, the optical element suffers a shape error corresponding to the shape. It suffices to express the shape error of an uncomplicated optical element such as a lens or mirror by a polynomial and calculate a deformation amount based on the term of a predetermined frequency or lower. Since the thickness of the optical element is a significant factor related to the deformation of the optical element, a low frequency is desirably evaluated at almost ½ the length at the thinnest portion of the optical element. The reason why only a low-frequency component is evaluated is that a small noise component exists in measurement and a high-frequency component can be excluded to increase the precision. At this time, expansion based on Zernike polynomials may be done or only a low-frequency component may be evaluated using a two-dimensional FFT. The Zernike polynomials, which are described in “Principles of Optics (p. 523)”, are independent polynomials each formed from a function of the radius and angle. Examples of the Zernike polynomials are Z₁=1, Z₂=ρ cos θ, Z₃=ρ sin θ, Z₄=2ρ²−1, . . . (Zₙ: each polynomial, ρ: distance from the center, θ: angle). Coefficients for the Zernike polynomials are calculated using the least squares method, and only a low-order Zernike polynomial is evaluated without evaluating a high-order one.

FIG. 6 shows measurement data S1 at 1 atm (P1) and measurement data S2 at 0.5 atm (P2) after the end of data processing. The air pressure difference PS between the pressure (atmospheric pressure) in the manufacture and the pressure (vacuum pressure) in exposure is 1 atm. In FIGS. 6, P1−P2 =0.5, so the deformation amount B that occurs owing to the air pressure difference can be calculated by doubling S1−S2. In FIGS. 6, P1 and P2 are 1 atm and 0.5 atm, respectively. However, the deformation amount B can be calculated as far as P1 and P2 are different air pressures. In FIG. 6, data at two air pressures P1 and P2 are used. Alternatively, measurement data may be acquired at three or more pressures to obtain the deformation amount B by approximation to polynomials.

The optical element manufacturing method according to the embodiment is applicable when manufacturing an optical element arranged in an apparatus used in the vacuum environment, such as an EUV exposure apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-093401, filed Apr. 7, 2009, which is hereby incorporated by reference herein in its entirety.

What is claimed is:

1. A method of processing an optical member at a first air pressure, thereby manufacturing an optical element used at a second air pressure different from the first air pressure, the method comprising:
a measuring step of measuring a surface shape of the optical member at the first air pressure;
a calculating step of calculating a deformation amount of the optical member that occurs owing to an air pressure difference between the first air pressure and the second air pressure; and
a processing step of processing the optical member at the first air pressure so as to make the surface shape of the optical member match a target shape at the second air pressure, based on the surface shape measured in the measuring step and the deformation amount calculated in the calculating step.

2. The method according to claim 1, wherein in the calculating step, the deformation amount is calculated based on a difference between surface shapes of the optical member measured at a plurality of pressures which are different from the second air pressure and different from each other.

3. The method according to claim 2, wherein the difference is expressed by a polynomial and the deformation amount is calculated based on a term of not more than a predetermined frequency in the polynomial.

4. The method according to claim 1, wherein
the surface shape of the optical member is an aspherical shape, and
the calculating step includes
a step of approximating the surface shape measured in the measuring step by an aspherical expression including a spherical term component and an aspherical term component; and
a step of calculating the deformation amount from a change amount of the spherical term component based on the air pressure difference between the first air pressure and the second air pressure.

5. The method according to claim 4, wherein the change amount is expressed by a polynomial and the deformation amount is calculated based on a term of not more than a predetermined frequency in the polynomial.

6. The method according to claim 1, wherein the first air pressure is a vacuum pressure and the second air pressure is an atmospheric pressure.
